(19) United States
(12) Patent Application Publication
(10) Pub. No.: US 2012/0059642 A1
(43) Pub. Date: Mar. 8, 2012

(54) METHOD AND DEVICE FOR THE ANGLE SENSOR-FREE DETECTION OF THE POSITION OF THE ROTOR SHAFT OF A PERMANENTLY EXCITED SYNCHRONOUS MACHINE ON THE BASIS OF CURRENT SIGNALS AND VOLTAGE SIGNALS

(76) Inventors: Ulrich Vollmer, Bissingen (DE); Matthias Bitzer, Stuttgart (DE)

(21) Appl. No.: 13/254,812

(22) PCT Filed: Jan. 11, 2010
(86) PCT No.: PCT/EP10/50183

§ 371 Date: Nov. 9, 2011

(30) Foreign Application Priority Data
Mar. 4, 2009 (DE) 10 2009 001 331.8

(51) Int. Cl. G06G 7/62

(52) U.S. Cl. 703/13

(57) ABSTRACT

Disclosed are a device and a method for determining position information of the rotor shaft of an electric machine based on at least one recorded input signal of the electric machine, the recorded input signal being supplied to a model of the electric machine. The position information of the rotor shaft is determined with the aid of the model, based on the supplied input signal, the model mapping nonlinear saturation effects of the electric machine. The model of the electric machine is an extended Kalman filter in which the nonlinear saturation effects of the electric machine are described by a polynomial.

### FIELD OF THE INVENTION

The present invention relates to a method and a device for the angle sensor-free detection of the position of the rotor shaft of a permanently excited synchronous machine on the basis of current signals and voltage signals.

### BACKGROUND

Modern synchronous machines are frequently used in various sizes and output classes, since due to their low wear and constant rotational speed they are superior to asynchronous machines and direct current motors in many applications. However, to allow permanent magnet-excited synchronous machines to be operated at variable rotational speed, a magnetic field must rotate synchronously with the rotor of the machine. For this synchronicity, the position of the rotor shaft, the so-called rotor angle, must be known and a constantly rotating magnetic field must be generated.

A method and a device are known from published German Patent Application DE 10 2007 052 365 for detecting the position of the rotor shaft of a permanently excited synchronous machine, the rotor angle being determined with the aid of an additional angle sensor.

A method is known from published German Patent Application DE 100 36 869 which determines the rotor position in a claw pole machine with the aid of a model and a state observer.

However, these known methods have the disadvantage that they either have additional sensors for determining the rotor angle, or use inadequate machine models, which in turn results in inaccurate determination of the rotor angle.

### SUMMARY

The method according to the present invention having the features described herein advantageously determines the position information of the rotor shaft of an electric machine based on at least one recorded input signal of the electric machine, the recorded input signal being supplied to a model of the electric machine; the position information of the rotor shaft being determined with the aid of the model, based on the supplied input signal; and the model mapping nonlinear saturation effects of the electric machine.

Advantageous embodiments and refinements of the present invention are made possible by the measures stated described herein.

In accordance with the present invention, “position information of the rotor shaft” is understood to mean the rotational speed and/or the rotation angle of the rotor shaft.

In the method in accordance with the present invention, the position, i.e., the angle of the rotor of a permanently excited synchronous machine, may be determined without using an angle sensor by exploiting the voltage signals and/or current signals supplied to the machine.

Furthermore, a model-based estimation algorithm and/or a dynamic model of the permanently excited synchronous machine, for example in the form of a Kalman filter, extended Kalman filter, or unscented Kalman filter, may be used for estimating and/or determining the rotor angle.

The Kalman filter is a so-called model-based estimation algorithm composed of a simulator component and a correction term. The simulator component includes a physical/dynamic model of the synchronous machine, and is used as an online simulator which is driven by measured data. In order to compensate for any model uncertainties, the simulator component is provided with a correction term, analogous to the feedback in a regulation system, in order to correct the variables thus estimated by the simulator in such a way that these variables converge toward the corresponding physical values, thus allowing for a stable regulation.

Furthermore, a machine model may be used which maps the nonlinear magnetic saturation conditions of the soft magnetic components of the synchronous machine. As a result, the actual behavior of the synchronous machine and, correspondingly, the rotor angle, may be determined with greater accuracy.

The nonlinear magnetic saturation effects may be detected and mapped with the aid of phenomenological approaches. This procedure advantageously results in a model which on the one hand has high accuracy due to mapping of the important physical effects, and which on the other hand is compact and rapid enough to be computed on an appropriate control unit in real time.

Within the meaning of the present invention, “phenomenological” means based on measurements, observations, and/or findings. The data used may be obtained in real time via measurements, or may be retrieved from a memory.

In addition, the nonlinear saturation effects of the electric machine may be described by a polynomial. The polynomial may be nth-order, where n is equal to 1, 2, 3, 4, 5, 6, 7, 8, 9, or 10. The individual coefficients of the polynomial may be determined using measured data, or may correspond to predefined values.

Furthermore, the model may contain a mechanical submodel. Use of a mechanical submodel allows more accurate determination of the rotor angle.

The input signal supplied to the model may be a phase current I_{abc} or I_{αβ} supplied to the electric machine, a load torque M_{load} output by the electric machine, the applied voltages U_{abc} or U_{αβ}, or a rotational speed ω of the rotor shaft of the electric machine.

The electric machine may be a synchronous machine, in particular a permanently excited synchronous machine or a reluctance machine. A permanently excited synchronous machine has the advantage that the excitation occurs via permanent magnets, so that it is not necessary to provide an exciter winding.

The model may also be supplied with at least one output signal of the electric machine. It is thus possible to develop a simple and robust controlled system.

The following electric machine equations represent the starting point for modeling the synchronous machine:

The electric machine equations in phase coordinates (abc):

$$\frac{d ψ}{d t} = U - RI$$

are transformed into the fixed-rotor dq coordinate system with the aid of known coordinate transformation, resulting in

$${\dot{ψ}}_{d} ( {I}_{d} , {I}_{q} ) = {U}_{d} - {RI}_{d} + N {ωψ}_{q} ( {I}_{d} , {I}_{q} )$$

$${\dot{ψ}}_{q} ( {I}_{d} , {I}_{q} ) = \underbrace{{U}_{d} - {RI}_{d} + N {ωψ}_{q} ( {I}_{d} , {I}_{q} )}_{f ( {I}_{d} , {I}_{q} , ω , {U}_{d} , {U}_{q} )} ,$$

in which
U=vector for the terminal voltages;
I=vector for the phase currents;
R=resistor matrix;
ψ=flux linkage;

$$\frac{d ψ}{d t}$$

=time derivative of vector ψ of the flux linkage;
I_{abc}=vectorial phase current in the reference system;
I_{αβ}=vectorial current in the fixed-rotor rectangular two-phase system;
I_{d}, I_{q}=phase currents in the fixed-rotor dq coordinate system;
I_{dq}=vectorial phase current as functions of phase current I_{abc} and of (rotation) angle φ;
U_{abc}=phase voltage (vectorial) in the reference system;
U_{aβ}=voltage (vectorial) in the fixed-rotor rectangular two-phase system;
U_{d}, U_{q}=phase voltages in the fixed-rotor dq coordinate system; and
ψ_{d}, ψ_{q}=flux linkages in the fixed-rotor dq coordinate system.

As a rule, the electrical model equations are formulated based on the currents as states, since the currents, unlike the flux linkages, are measurable. The following equations are thus obtained:

$$[ \begin{matrix}{\dot{I}}_{d} \\ {\dot{I}}_{q}\end{matrix} ] = \prod {( {I}_{d} , {I}_{q} )}^{- 1} f ( {I}_{d} , {I}_{q} , ω , {U}_{d} , {U}_{q} )$$

### Where

$$[ \begin{matrix}{\dot{ψ}}_{d} \\ {\dot{ψ}}_{q}\end{matrix} ] = \underbrace{[ \begin{matrix}\frac{\partial {ψ}_{d}}{\partial {I}_{d}} & \frac{\partial {ψ}_{d}}{\partial {I}_{q}} \\ \frac{\partial {ψ}_{q}}{\partial {I}_{d}} & \frac{\partial {ψ}_{q}}{\partial {I}_{q}}\end{matrix} ]}_{Π ( {I}_{d} , {I}_{q} )} [ \begin{matrix}{\dot{I}}_{d} \\ {\dot{I}}_{q}\end{matrix} ]$$

However, there is the problem that matrix H must be inverted, which may result in singularities and a more complex model description. Therefore, according to the present invention the estimation algorithm is derived using flux linkages ψ_{d}, ψ_{q} as states.

In order to map the nonlinear magnetic saturation effects, according to the present invention phenomenological approaches are used. For this purpose, currents I_{d}, I_{q} are applied as nonlinear functions of rotor flows ltf_{d}, Iti_{q}, i.e.:

I_{d}=I_{d}(ψ_{d},ψ_{q})

I_{q}=I_{q}(ψ_{d},ψ_{q})

The following dynamic electrical model equations are thus obtained:

\hat{ψ}_{d}=U_{d}−RI_{d}(ψ_{d},ψ_{q})+Nωψ_{q}

\hat{ψ}_{q}=U_{q}−RI_{q}(ψ_{d},ψ_{q})−Nωψ_{d}

One possible phenomenological approach is composed of the following nth-order polynomials, for example:

I_{d}^{P}^{⁰}(ψ_{d},ψ_{q})=(a_{d00}+a_{d02}ψ_{q}²)+(a_{d10}+a_{d12}ψ_{q}²)ψ^{d}+(a_{d20}+a_{d22}ψ_{q}²)ψ_{d}²+(a_{d30}+a_{d32}ψ_{q}²)ψ_{d}³

I_{q}^{P}^{⁰}(ψ_{d},ψ_{q})=(a_{q10}+a_{q11}ψ_{d}+a_{q12}ψ_{d}²)ψ_{q}+(a_{q30}+a_{q31}ψ_{d}+a_{q32}ψ_{d}²)ψ_{q}³

The electrical model is to be further supplemented with a mechanical submodel, so that the following model equations are ultimately obtained:

$${\dot{ψ}}_{d} = {U}_{d} - {RI}_{d} ( {ψ}_{d} , {ψ}_{q} ) + N {ωψ}_{q}$$

$${\dot{ψ}}_{q} = {U}_{q} - {RI}_{q} ( {ψ}_{d} , {ψ}_{q} ) - N {ωψ}_{d}$$

$$\dot{ω} = \frac{3 N}{2 J} [ {ψ}_{d} {I}_{q} ( {ψ}_{d } , {ψ}_{q} ) - {ψ}_{q} {I}_{d} ( {ψ}_{d} , {ψ}_{q} ) ] - \frac{{K}_{R}}{J} ω - \frac{1}{J} {M}_{L}$$

$$\dot{ϕ} = ω$$

Since the currents are measured variables, the following measurement equation also applies:

y=[I_{d}(ψ_{d},ψ_{q}),I_{q}(ψ_{d},ψ_{q})]^{T}

Load torque M_{L} which appears in the model is an unknown variable, and therefore a disturbance variable approach is also used to complete the overall model. Any desired previously known value may be used for the load torque; here, one common procedure is to set the time derivative of the load torque to 0 (zero):

\dot{M}_{L}=0

Overall, a nonlinear model of the following form is then obtained:

Σ:\dot{x}=f(x,u)t>0,x(0)=x₀

y=h(x),t≧0

In order to formulate the model equations as stated above with the aid of the dq coordinate system, it is necessary to know rotation angle φ (position) to be estimated. The relationship between the co-rotating fixed-rotor dq coordinate system and the (stationary) fixed-stator αβ coordinate system is used as an example and is represented by rotation matrix T(φ):

$$T ( ϕ ) = [ \begin{matrix}cos ( N ϕ ) & sin ( N ϕ ) \\ - sin ( N ϕ ) & cos ( N ϕ )\end{matrix} ]$$

Since from a physical standpoint only the “fixed-stator” currents I_{αβ}=[I_{α}, I_{β}] are measurable, i.e., voltages U_{αβ}=[U_{α}, U_{β}] may be predefined as manipulated variables for a regulation system, the linear model must be extended on the input and output sides using rotation matrix T(φ) or the inverse thereof, T¹(φ). Thus, the following is obtained as a nonlinear model equation:

f(x,u)=f_{ψ}(x)+BT(φ)u

in which

$${f}_{ψ} ( x ) = [ \begin{matrix}{U}_{d} ( {U}_{α} , {U}_{β} , ϕ ) - {RI}_{d} ( {ψ}_{d} , {ψ}_{q} ) + N {ωψ}_{q} \\ {U}_{q} ( {U}_{α} , {U}_{β} , ϕ ) - {RI}_{q} ( {ψ}_{d} , {ψ}_{q} ) + N {ωψ}_{d} \\ \frac{3 N}{2 J} ( {ψ}_{d} {I}_{q} ( {ψ}_{d } , {ψ}_{q} ) - {ψ}_{q} {I}_{d} ( {ψ}_{d} , {ψ}_{q} ) ) - \frac{{K}_{R}}{J} ω - \frac{1}{J} {M}_{L} \\ ω \\ 0\end{matrix} ]$$

$$B = {[ \begin{matrix}1 & 0 & 0 & 0 & 0 \\ 0 & 1 & 0 & 0 & 0\end{matrix} ]}^{T} T ( ϕ ) = [ \begin{matrix}cos ( N ϕ ) & sin ( N ϕ ) \\ - sin ( N ϕ ) & cos ( N ϕ )\end{matrix} ]$$

or as the output or measurement equation:

$$y = h ( x ) = [ \begin{matrix}{I}_{α} ( {I}_{d} , {I}_{q} , ϕ ) \\ {I}_{β} ( {I}_{d} , {I}_{q} , ϕ )\end{matrix} ] = \underbrace{[ \begin{matrix}cos ( N ϕ ) & - sin ( N ϕ ) \\ sin ( N ϕ ) & cos ( N ϕ )\end{matrix} ]}_{{T}^{- 1} ( ϕ )} \cdot [ \begin{matrix}{I}_{d} ( {ψ}_{d} , {ψ}_{q} ) \\ {I}_{q} ( {ψ}_{d} , {ψ}_{q} )\end{matrix} ]$$

The present invention is explained in greater detail below with reference to the appended drawings used as examples.

### BRIEF DESCRIPTION OF THE DRAWINGS

FIG. 1 shows the dq fundamental wave model, using an input/output transformation;

FIG. 2 shows a predictor-corrector structure of an extended Kalman filter.

FIG. 3 shows an extended Kalman filter for permanently excited synchronous machines.

FIGS. 4a to 4c show angle errors and angular velocity errors from designed estimation methods based on various-order polynomial expressions for the phenomenological saturation description.

### DETAILED DESCRIPTION

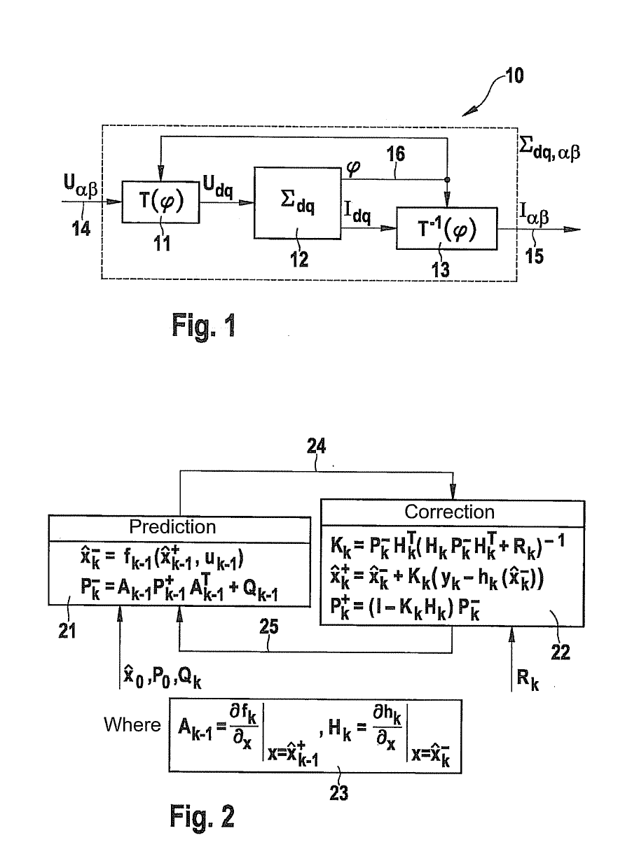

FIG. 1 shows a schematic layout of a dq fundamental wave model using input/output transformation. The input variable of the electric machine, i.e., machine voltage U_{αβ}14 in the fixed-stator or stationary αβ coordinate system, is transformed into input signal U_{dq} in the fixed-rotor dq coordinate system, using a rotation matrix T(φ) 11.

Transformed input signal U_{dq} is entered into a machine model Σ_{dq} 12. Machine model Σ_{dq} 12 has estimated rotation angle φ (position) 16 and machine currents I_{dq} as output variables. Fixed-rotor machine currents I_{dq} are transformed back into fixed-stator machine currents I_{αβ} 15, i.e., into the output variable, using inverse rotation matrix T¹(φ) 13. Rotation angle φ 16 is supplied to rotation matrix T(φ) 11 and to inverse rotation matrix T¹(φ) 13, in which the following apply:

$$T ( ϕ ) = [ \begin{matrix}cos ( N ϕ ) & sin ( N ϕ ) \\ - sin ( N ϕ ) & cos ( N ϕ )\end{matrix} ]$$

$$and$$

$${T}^{- 1} ( ϕ ) = [ \begin{matrix}cos ( N ϕ ) & - sin ( N ϕ ) \\ sin ( N ϕ ) & cos ( N ϕ )\end{matrix} ]$$

FIG. 2 shows an example of a predictor-corrector structure of an extended Kalman filter. For use of the proposed estimation algorithm in the control unit, a change is to be made which results in a time-discrete model formulation of the form:

Σ:xₖ=fₖ₋₁(xₖ₋₁,uₖ₋₁)+wₖ₋₁,k>0,x(t=0)=x₀

yₖ=hₖ(xₖ)+vₖ,k≧0

Using this approach, a Kalman filter may ultimately be derived directly, based on known methods.

One possible characteristic form is the selection of the outlined predictor-corrector structure of an extended Kalman filter. Block 21 corresponds to the prediction portion of the predictor-corrector structure. Block 21 is supplied with signals \hat{x}₀, P₀, Qₖ. During the prediction, state \hat{x}ₖ⁻ is computed as follows, with the aid of estimated state \hat{x}ₖ₋₁, from prior correction step k−1 (a priori estimation), i.e., as a function of \hat{x}ₖ₋₁⁺,uₖ₋₁:

\hat{x}ₖ⁻=f^{k-1}(\hat{x}ₖ₋₁⁺,uₖ₋₁)

Error covariance matrix Pₖ⁻ expected for the prediction is computed from:

Pₖ⁻=Aₖ₋₁·Pₖ₋₁⁺·Aₖ₋₁^{T}+Qₖ₋₁

where

$${A}_{k - 1} = \frac{\partial {f}_{k}}{\partial x} {\vert}_{x = {\hat{x}}_{k - 1}^{+}}$$

in which Qₖ₋₁ represents the covariance matrix for the process noise, and therefore corresponds to a model error which describes the deviation of the model behavior from reality.

Estimated state \hat{x}ₖ⁻ and error covariance matrix Pₖ⁻ of block 21 are supplied to block 22 with the aid of a coupling 24. The prediction is corrected in block 22. The weighting of the correction with respect to the prediction determines the so-called Kalman gain corresponding to prediction error covariance matrix Pₖ⁻ and measurement error covariance matrix Rₖ:

Kₖ=Pₖ⁻Hₖ(HₖPₖ⁻Hₖ^{T}+Rₖ)

Furthermore, prediction \hat{x}ₖ⁻ is weighted during the correction to form a new (a posteriori) estimation:

\hat{x}ₖ⁺=\hat{x}ₖ⁻+Kₖ(yₖ−hₖ(\hat{x}ₖ⁻))

The error covariance matrix associated with this estimation is as follows, for example:

Pₖ⁺=(I−KₖHₖ)Pₖ⁻

where

$${H}_{k} = \frac{\partial {h}_{k}}{\partial x} {\vert}_{x = {\hat{x}}_{k}^{-}} ,$$

in which I corresponds to the unit matrix. The equation for determining the a posteriori error covariance matrix may also be executed in other characteristic forms; alternatively, it may be computed, for example, using the somewhat more complex “Joseph form” known from the literature. Both a posteriori estimated values then form the basis for a new pass for estimating the next system state, and the sequence starts over again.

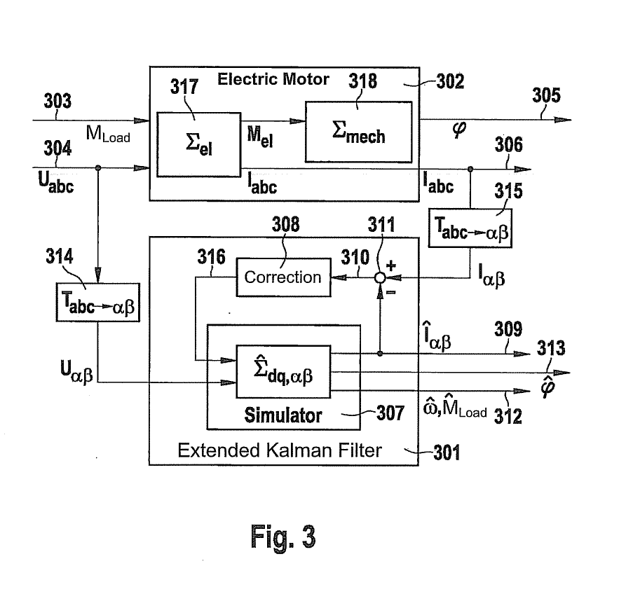

FIG. 3 shows a schematic layout of an extended Kalman filter 301 which is connected to an electric machine 302 to be observed. Electric machine 302 to be observed has at least two inputs for input signals 303, 304, as well as at least two outputs for output signals 305, 306. Input signal 303 may correspond to a load torque, and input signal 304 may correspond to one or multiple phase voltages or phase currents. Output signal 306 may correspond to at least one system state I_{abc}, and output signal 305 may correspond to an unmeasured variable such as rotation angle φ.

Kalman filter 301 is composed of a simulator portion 307 and a correction portion 308. Simulator portion 307 represents a complete machine model of electric machine 302. Simulator portion 307 is acted on by the same input signal 304 that acts on electric machine 302. Simulator portion 307 emits two types of signals: a reconstructed output signal 309, which corresponds to an estimated measured variable, and output signals 312 and 313, which correspond to estimated system states. If the parameters as well as initial values in parallel model 301 and system 302 to be observed are identical, reconstructed output signal 309 is then equal to output signal 306 of electric machine 302.

However, since the parallel model in simulator portion 307 is not able to exactly map electric machine 302, a difference signal 310 between reconstructed output signal 309 and output signal 306 results, which is computed with the aid of subtraction 311 involving reconstructed output signal 309 and output signal 306. This difference signal 310 is then supplied to correction portion 308. Correction portion 308 computes a correction signal 316, which in turn is supplied to simulator portion 307. Output signal 309 of simulator portion 307 may be influenced by correction signal 316. This is carried out until difference signal 310 converges to a limiting value.

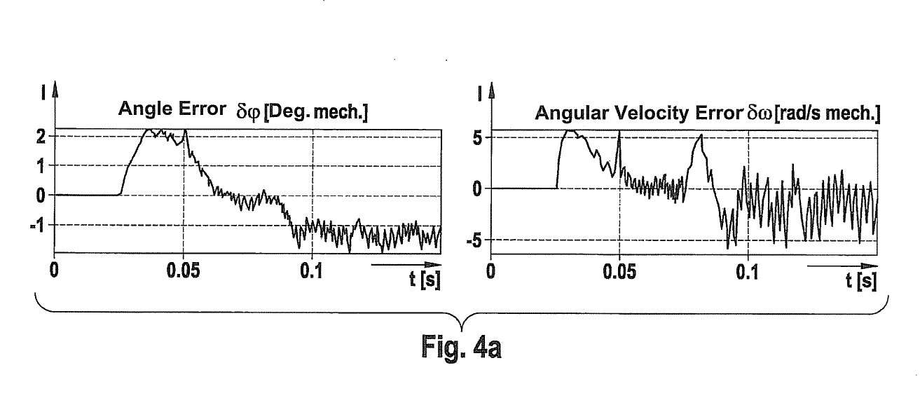

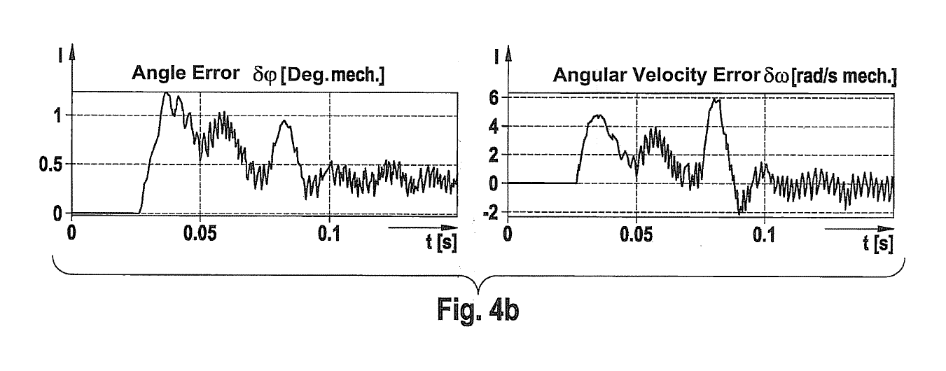

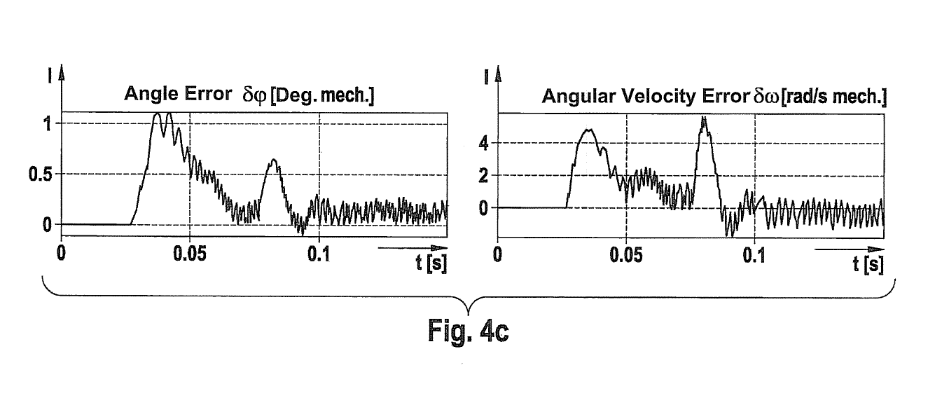

FIG. 4 shows, for various-order polynomials, the angle error and the angular velocity error of the model used. The lowest-order polynomial is used as an example in FIG. 4a), and the highest-order polynomial is shown in FIG. 4c). As is apparent from FIGS. 4a) through 4c), the angle error and the angular velocity error decrease as the order of the applied polynomial increases. The angle error in FIG. 4a may have values between +2 and −2 degrees, the angle error in FIG. 4c being between +1.5 and −0.5 degrees. The same applies for the angular velocity error. The angular velocity error in FIG. 4a may have values between +5 and −5 degrees, while the angular velocity error in FIG. 4c is between +6 and −2 degrees.

A method and a device for determining position information of the rotor shaft of an electric machine based on at least one recorded input signal of the electric machine have been described, the recorded input signal being supplied to a model of the electric machine; the position information of the rotor shaft being determined with the aid of the model, based on the supplied input signal; and the model mapping nonlinear saturation effects of the electric machine.

Based on the above description it is apparent that, although preferred and exemplary specific embodiments have been illustrated and described, various modifications may be made without departing from the basic concept of the present invention. Accordingly, as a result of the detailed description of the preferred and exemplary specific embodiments, the present invention is not to be construed as being limited thereto.

1-11. (canceled)

12. A method for determining position information of a rotor shaft of an electric machine based on at least one recorded input signal of the electric machine, the method comprising:
supplying the recorded input signal to a model of the electric machine, the model mapping nonlinear saturation effects of the electric machine; and
determining the position information of the rotor shaft with the aid of the model, based on the supplied input signal.

13. The method as recited in claim 12, wherein the model is an extended Kalman filter.

14. The method as recited in claim 12, wherein the nonlinear saturation effects of the electric machine are described by a polynomial.

15. The method as recited in claim 14, wherein the coefficients of the polynomial are determined using measured data.

16. The method as recited in claim 12, wherein the model includes a mechanical submodel.

17. The method as recited in claim 12, wherein the input signal is (a) a phase current, (b) a load torque, or (c) a rotational speed of the electric machine.

18. The method as recited in claim 12, wherein the electric machine is a synchronous machine.

19. The method as recited in claim 18, wherein the asynchronous machine is a permanently excited synchronous machine or a reluctance machine.

20. The method as recited in claim 12, wherein at least one output signal of the electric machine is supplied to the model.

21. A device configured to determine position information of a rotor shaft of an electric machine, the device comprising:
a measuring device configured to detect at least one input signal of the electric machine,
a model of the electric machine, the model mapping nonlinear saturation effects of the electric machine; and
a computing device configured to determine the position information of the rotor shaft with the aid of the model, based on a recorded input signal supplied to the model of the electric machine.

22. A non-transitory computer-readable medium containing instructions that cause a computer to execute the method as recited in claim 12.
